(19) United States
(12) Patent Application Publication
(10) Pub. No.: US 2021/0156883 A1
(43) Pub. Date: May 27, 2021

(54) Fluid Hose Splice Assembly

(71) Applicant: Mark Priebe, N Olmsted, OH (US)

(72) Inventor: Mark Priebe, N Olmsted, OH (US)

(21) Appl. No.: 16/695,295

(22) Filed: Nov. 26, 2019

(51) Int. Cl. G01P 13/00; F16L 21/00; F16L 37/04

(52) U.S. Cl. CPC G01P 13/008; F16L 2201/10; F16L 37/04; F16L 21/002

(57) ABSTRACT

A fluid hose splice assembly for visually diagnosing fluid flowing through a fluid hose includes a tube that is spliceable into an existing fluid hose such that a fluid flows through the tube. The tube is comprised of a translucent material thereby facilitating the fluid to be visible through the tube for diagnostic observation of the fluid. The tube has a plurality of observation windows that are each integrated into the tube. Each of the observation windows is convexly arcuate with respect to the tube to enhance visibility of the fluid flowing through the tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to splice devices and more particularly pertains to a new splice device for visually diagnosing fluid flowing through a fluid hose.

### (2) Description of Related Art Including Information Disclosed Under 37 CFR 1.97 and 1.98

The prior art relates to splice devices.

### BRIEF SUMMARY OF THE INVENTION

An embodiment of the disclosure meets the needs presented above by generally comprising a tube that is spliceable into an existing fluid hose such that a fluid flows through the tube. The tube is comprised of a translucent material thereby facilitating the fluid to be visible through the tube for diagnostic observation of the fluid. The tube has a plurality of observation windows that are each integrated into the tube. Each of the observation windows is convexly arcuate with respect to the tube to enhance visibility of the fluid flowing through the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fluid hose splice assembly according to an embodiment of the disclosure.

FIG. 2 is a top view of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DETAILED DESCRIPTION OF THE INVENTION

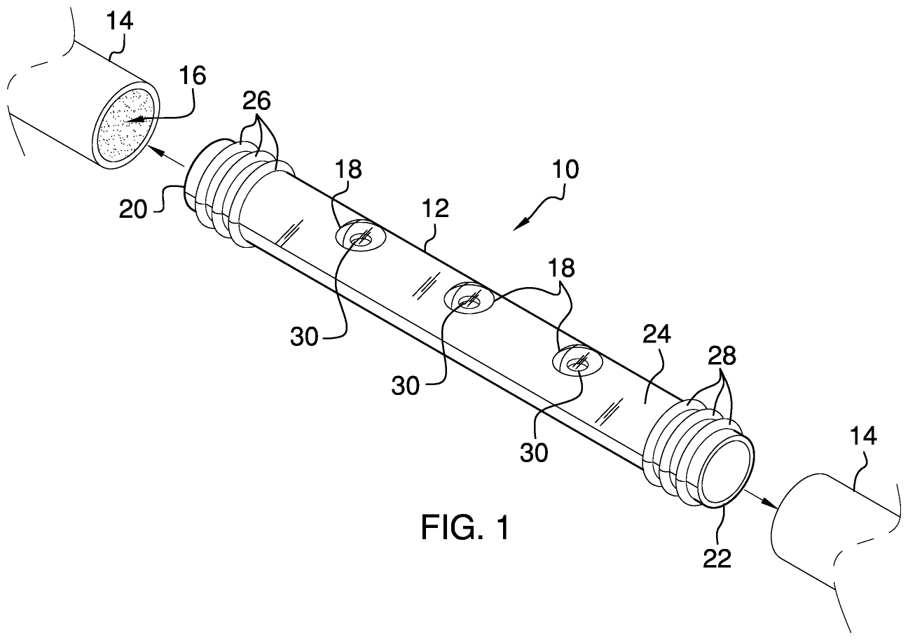

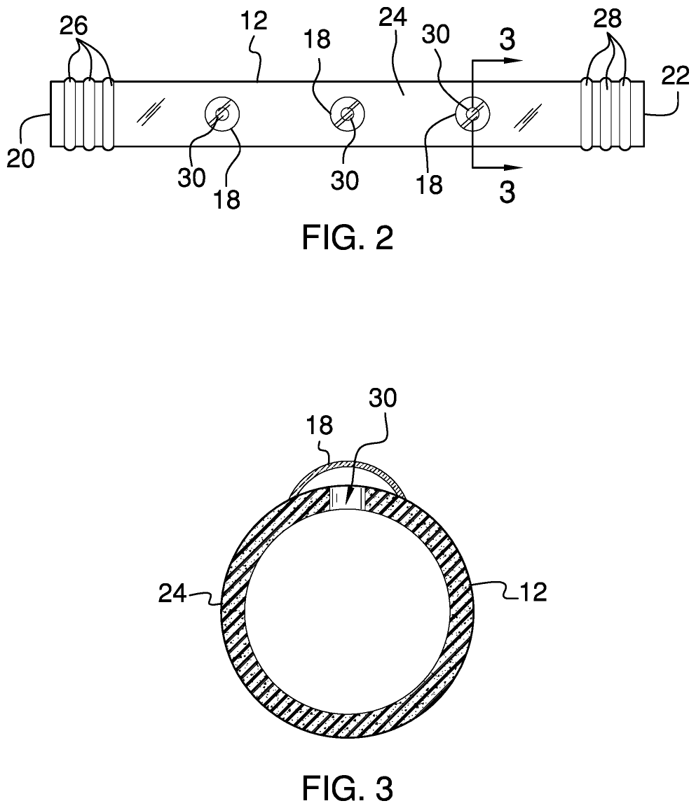

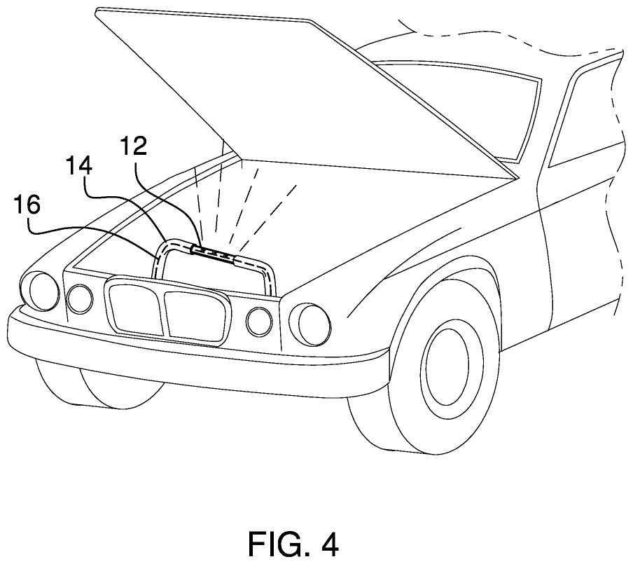

With reference now to the drawings, and in particular to FIGS. 1 through 4 thereof, a new splice device embodying the principles and concepts of an embodiment of the disclosure and generally designated by the reference numeral 10 will be described.

As best illustrated in FIGS. 1 through 4, the fluid hose splice assembly 10 generally comprises a tube 12 that is spliceable into an existing fluid hose 14. In this way a fluid 16 flow can flow through the tube 12. The existing fluid hose 14 may be a fluid hose on an engine of a vehicle, such as a coolant hose or the like. The fluid 16 may be coolant or other fluid that would commonly be used in the engine. The tube 12 is comprised of a translucent material thereby facilitating the fluid 16 to be visible through the tube 12 wherein the tube 12 is configured to facilitate diagnostic observation of the fluid 16. Additionally, the tube 12 may be comprised of a resiliently deformable material thereby facilitating the tube 12 to be curved, if necessary, to fit with the existing fluid hose 14. The tube 12 may be manufactured in a variety of lengths and diameters to accommodate a variety of sizes of existing fluid hoses.

The tube 12 has a plurality of observation windows 18 that are each integrated into the tube 12. Additionally, each of the observation windows 18 is convexly arcuate with respect to the tube 12 to enhance visibility of the fluid 16 flowing through the tube 12. The tube 12 has a first end 20, a second end 22 and an outer wall 24 extending therebetween. The outer wall 24 has a set of first ridges 26 each extending outwardly therefrom and each of the first ridges 26 extends around a full circumference of the outer wall 24. The first ridges 26 are spaced apart from each other and are distributed from the first end 20 of the tube 12 toward the second end 22 of the tube 12. Moreover, the first end 20 of the tube 12 is insertable into an opening in the existing fluid hose 14 thereby facilitating each of the first ridges 26 to frictionally engage the existing fluid hose 14. In this way the first end 20 of the tube 12 is retained in the existing fluid hose 14.

The outer wall 24 has a set of second ridges 28 each extending outwardly therefrom. Each of the second ridges 28 extends around a full circumference of the outer wall 24. The second ridges 28 are spaced apart from each other and are distributed from the second end 22 of the tube 12 toward the first end 20 of the tube 12. Additionally, the second end 22 of the tube 12 is insertable into an opening in the existing fluid hose 14 thereby facilitating each of the second ridges 28 to frictionally engage the existing fluid hose 14. In this way the second end 22 of the tube 12 is retained in the existing fluid hose 14.

The outer wall 24 of the tube 12 has a plurality of openings 30 each extending into an interior of the tube 12. The openings 30 are spaced apart from each other and are distributed between the first ridges 26 and the second ridges 28. Each of the observation windows 18 is positioned on the outer wall 24 of the tube 12 and each of the observation windows 18 is aligned with a respective one of the openings 30 in the outer wall 24 of the tube 12. A pair of hose clamps, or other type of fastener, can be tightened around the junctions between the existing fluid hose 14 and the tube 12 to inhibit fluid 16 leaking at the junctions.

In use, the existing fluid hose 14 is cut when the flow of fluid 16 through the existing fluid hose 14 needs to be inspected for diagnostic purposes. The tube 12 is spliced into the existing fluid hose 14 and the existing fluid hose 14 is exposed to the flow of fluid 16. Thus, the translucent properties of the tube 12, along with the observation windows 18, facilitate the flow of fluid 16 to be visible during a diagnostic procedure. In this way a fluid flow problem, such as a plugged radiator, a faulty water pump or other similar mechanical problem, can be visually diagnosed. The existing fluid hose 14 can be replaced or repaired upon completion of the diagnostic procedure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid hose splice assembly being configured to be spliced into a fluid hose thereby facilitating a flow of fluid through the fluid hose to be visible for diagnostic purposes, said assembly comprising:
a tube being spliceable into an existing fluid hose wherein said tube is configured to have a fluid flow therethrough, said tube being comprised of a translucent material thereby facilitating the fluid to be visible through said tube wherein said tube is configured to facilitate diagnostic observation of the fluid, said tube having a plurality of observation windows each being integrated into said tube, each of said observation windows being convexly arcuate with respect to said tube wherein each of said windows is configured to enhance visibility of the fluid flowing through said tube.

2. The assembly according to claim 1, wherein said tube has a first end, a second end and an outer wall extending therebetween, said outer wall having a set of first ridges each extending outwardly therefrom, each of said first ridges extending around a full circumference of said outer wall, said first ridges being spaced apart from each other and being distributed from said first end of said tube toward said second end of said tube.

3. The assembly according to claim 2, wherein said first end of said tube is insertable into an opening in the existing fluid hose thereby facilitating each of said first ridges to frictionally engage the existing fluid hose for retaining said first end of said tube in the existing fluid hose.

4. The assembly according to claim 2, wherein said outer wall has a set of second ridges each extending outwardly therefrom, each of said second ridges extending around a full circumference of said outer wall, said second ridges being spaced apart from each other and being distributed from said second end of said tube toward said first end of said tube.

5. The assembly according to claim 4, wherein said second end of said tube is insertable into an opening in the existing fluid hose thereby facilitating each of said second ridges to frictionally engage the existing fluid hose for retaining said second end of said tube in the existing fluid hose.

6. The assembly according to claim 4, wherein said outer wall of said tube has a plurality of openings each extending into an interior of said tube, said openings being spaced apart from each other and being distributed between said first ridges and said second ridges.

7. The assembly according to claim 6, wherein each of said windows is positioned on said outer wall of said tube, each of said windows being aligned with a respective one of said openings in said outer wall of said tube.

8. A fluid hose splice assembly being configured to be spliced into a fluid hose thereby facilitating a flow of fluid through the fluid hose to be visible for diagnostic purposes, said assembly comprising:
a tube being spliceable into an existing fluid hose wherein said tube is configured to have a fluid flow therethrough, said tube being comprised of a translucent material thereby facilitating the fluid to be visible through said tube wherein said tube is configured to facilitate diagnostic observation of the fluid, said tube having a plurality of observation windows each being integrated into said tube, each of said observation windows being convexly arcuate with respect to said tube wherein each of said windows is configured to enhance visibility of the fluid flowing through said tube, said tube having a first end, a second end and an outer wall extending therebetween, said outer wall having a set of first ridges each extending outwardly therefrom, each of said first ridges extending around a full circumference of said outer wall, said first ridges being spaced apart from each other and being distributed from said first end of said tube toward said second end of said tube, said first end of said tube being insertable into an opening in the existing fluid hose thereby facilitating each of said first ridges to frictionally engage the existing fluid hose for retaining said first end of said tube in the existing fluid hose, said outer wall having a set of second ridges each extending outwardly therefrom, each of said second ridges extending around a full circumference of said outer wall, said second ridges being spaced apart from each other and being distributed from said second end of said tube toward said first end of said tube, said second end of said tube being insertable into an opening in the existing fluid hose thereby facilitating each of said second ridges to frictionally engage the existing fluid hose for retaining said second end of said tube in the existing fluid hose, said outer wall of said tube having a plurality of openings each extending into an interior of said tube, said openings being spaced apart from each other and being distributed between said first ridges and said second ridges, each of said windows being positioned on said outer wall of said tube, each of said windows being aligned with a respective one of said openings in said outer wall of said tube.
